(19) United States
(12) Patent Application Publication
(10) Pub. No.: US 2013/0013297 A1
(43) Pub. Date: Jan. 10, 2013

(54) MESSAGE SERVICE METHOD USING SPEECH RECOGNITION

(75) Inventors: Hwa Jeon SONG, (US); YunKeun Lee, (US); Jeon Gue Park, Daejeon (KR); Jong Jin Kim, (US); Ki-Young Park, (US); Hoon Chung, (US); Hyung-Bae Jeon, (US); Ho Young Jung, (US); Euisok Chung, (US); Jeom Ja Kang, (US); Byung Ok Kang, (US); Sang Kyu Park, (US); Sung Joo Lee, (US); Yoo Rhee Oh, (US)

(73) Assignee: ELECTRONICS AND TELECOMMUNICATIONS RESEARCH INSTITUTE, Daejeon (KR)

(21) Appl. No.: 13/542,118

(22) Filed: Jul. 5, 2012

(30) Foreign Application Priority Data
Jul. 5, 2011 (KR) 10-2011-0066574

(51) Int. Cl. G10L 15/00

(52) U.S. Cl. 704/201; 704/E15.001

(57) ABSTRACT

A message service method using speech recognition includes a message server recognizing a speech transmitted from a transmission terminal, generating and transmitting a recognition result of the speech and N-best results based on a confusion network to the transmission terminal; if a message is selected through the recognition result and the N-best results and an evaluation result according to accuracy of the message are decided, the transmission terminal transmitting the message and the evaluation result to a reception terminal; and the reception terminal displaying the message and the evaluation result.

### CROSS-REFERENCES TO RELATED APPLICATIONS

The present application claims priority under 35 U.S.C. 119(a) to Korean Application No. 10-2011-0066574, filed on Jul. 5, 2011, in the Korean Intellectual Property Office, which is incorporated herein by reference in its entirety set forth in full.

### BACKGROUND

Exemplary embodiments of the present invention relate to a method for providing a message service through a smart phone, a computer, and the like, and more particularly, to a message service method using speech recognition, which provides a service to transfer and register a message through combination of the result of speech recognition with user's real speech.

Recently, devices, such as smart phones, smart pads, and the like, are explosively increasing, and in order to provide various services through such devices, infrastructure and performance improvement, such as a communication speed, a cloud computing type, and the like, have been continuously made.

Further, through the development of such a technology, part of services which were formerly difficult to be provided has become possible. Currently, in order to store user data, cloud-based data centers have been activated to eliminate the limit in storage capacity, and methods capable of uniting and utilizing such systems may be infinite.

In particular, even in service fields using speech recognition, unlimited continuous speech recognition which was difficult to be provided in the past has become possible almost in real time, and various services using this have been launched.

As an example, with the performance improvement of a message server based unlimited continuous speech recognition device, even applications, such as not only speech search but also dictation through a network, have been developed and serviced.

The background technology of the present invention is disclosed in Korean Unexamined Patent Publication No. 10-2004-0040543 (published on May 13, 2004).

### SUMMARY

Since the performance of the unlimited continuous speech recognition device is not satisfactory, an SMS service (Short Message service) or the like, which has been frequently mentioned as a service using an unlimited continuous speech recognition function in the related art, has not been widely used.

This is because a user should perform a large amount of correction due to the unsatisfactory result of speech recognition and thus the degree of satisfaction is not high as compared with an actual input through a keyboard in a portable phone or a smart phone.

An embodiment of the present invention relates to a message service method using speech recognition, which can provide a message through combination of the result of speech recognition with user's real speech and thus improve the accuracy and user convenience.

In one embodiment, a message service method using speech recognition includes: recognizing a speech transmitted from a transmission terminal; generating and transmitting a recognition result of the speech and N-best results based on a confusion network to the transmission terminal; and if a message selected by the transmission terminal and an evaluation result of accuracy of the message are transmitted, transmitting the message and the evaluation result to a reception terminal.

The message service method according to one embodiment may further include, if the message selected by the transmission terminal and the evaluation result of the accuracy of the message are transmitted, correcting an error of the recognition result by storing log data of the recognition result through storing of the message.

The message service method according to one embodiment may further include, if transmission of the speech is requested from the reception terminal, reading and transmitting the speech to the reception terminal.

In another embodiment, a message service method using speech recognition includes: receiving and transmitting a speech to a message server; receiving a recognition result of the speech and N-best results based on a confusion network from the message server; displaying the recognition result and the N-best results and determining whether a message is selected and an evaluation result of the message are decided according to the recognition result and the N-best results; and if the message and the evaluation result are decided, transmitting the message and the evaluation result to at least one of the message server and a reception terminal.

In the step of determining whether the message is selected and the evaluation result of the message is decided, the recognition result may be displayed with different colors by words, and if any one of the words is selected, any one of the N-best results of the selected word may be selected and displayed.

The message may be selected and decided from the N-best results for the recognition result through the transmission terminal.

The N-best results may be generated by words or sentences.

The evaluation result may include at least one of numeral values, characters, patterns, and symbols.

In still another embodiment, a message service method using speech recognition includes: receiving a message and an evaluation result from a transmission terminal or a message server; and displaying the message and the evaluation result.

The step of displaying the message and the evaluation result may further include, if the evaluation result is equal to or less than a set level, receiving the speech from the message server and automatically outputting the received speech.

As described above, the present invention can be applied to an SMS message, a messenger, an e-mail, and the like, through a minimum touch without using a keyboard in a smart phone.

Further, since the present invention can evaluate a simple memo for each recognized unit in association with an e-mail, a blogger, a tweeter, a face book, and the like, a user can upload writing to a user's website, and other users can select a portion having a low score and obtain accurate information through speech listening.

Further, a user can use a messenger, an SMS, a blogger, a tweeter, and the like, without typing on a keyboard in a smart phone and thus can naturally communicate with other persons.

### BRIEF DESCRIPTION OF THE DRAWINGS

The above and other aspects, features and other advantages will be more clearly understood from the following detailed description taken in conjunction with the accompanying drawings, in which:

FIG. 1 illustrates the configuration of a message service apparatus using speech recognition according to an embodiment of the present invention;

FIG. 2 illustrates a flowchart of a message service method using speech recognition according to an embodiment of the present invention;

FIG. 3 illustrates a diagram showing a screen of a transmission terminal according to an embodiment of the present invention;

FIG. 4 illustrates a diagram showing an example of N-best selection according to an embodiment of the present invention; and

FIG. 5 illustrates a diagram showing a screen of a reception terminal according to an embodiment of the present invention.

### DESCRIPTION OF SPECIFIC EMBODIMENTS

Hereinafter, a message service method using speech recognition according to an embodiment of the present invention will be described in detail with reference to accompanying drawings. In the drawings, line thicknesses or sizes of elements may be exaggerated for clarity and convenience. Also, the following terms are defined considering function of the present invention, and may be differently defined according to intention of an operator or custom. Therefore, the terms should be defined based on overall contents of the specification.

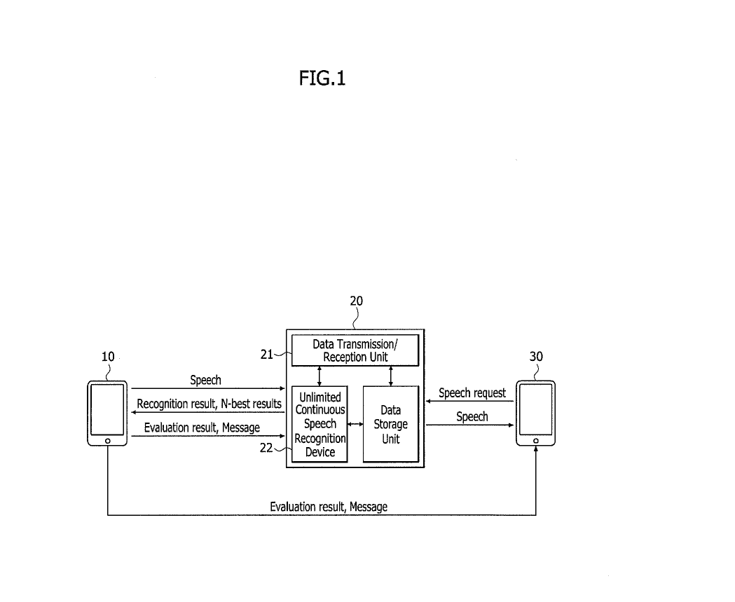

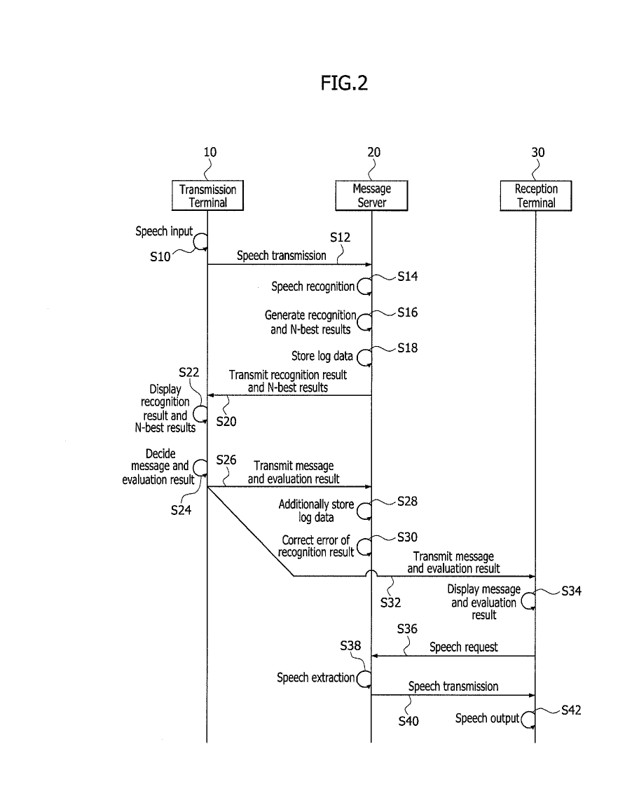

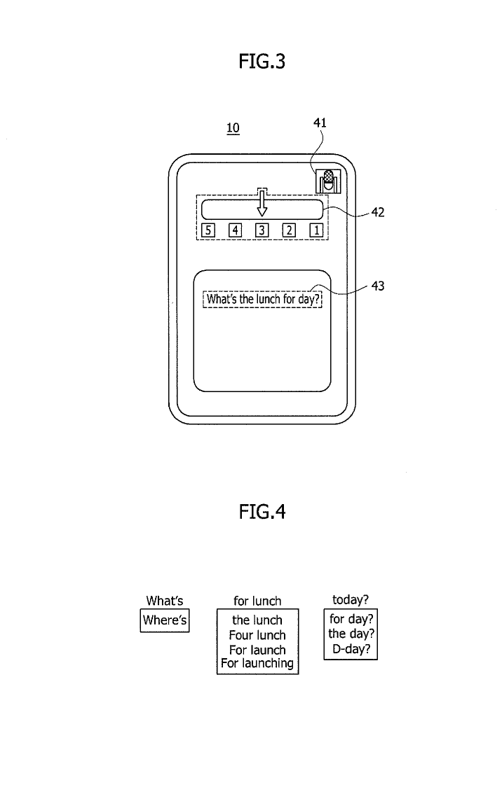

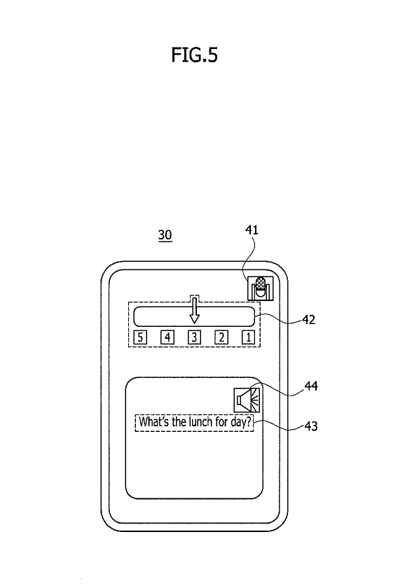

FIG. 1 illustrates the configuration of a message service apparatus using speech recognition according to an embodiment of the present invention, and FIG. 2 illustrates a flowchart of a message service method using speech recognition according to an embodiment of the present invention. FIG. 3 illustrates a diagram showing a screen of a transmission terminal according to an embodiment of the present invention, FIG. 4 illustrates a diagram showing an example of N-best selection according to an embodiment of the present invention, and FIG. 5 illustrates a diagram showing a screen of a reception terminal according to an embodiment of the present invention.

As illustrated in FIG. 1, a message service apparatus using speech recognition according to an embodiment of the present invention includes a transmission terminal 10, a message server 20, and a reception terminal 30.

The transmission terminal 10 may be one of various terminals, such as a smart phone, a personal computer, and the like, which makes it possible to register writing of an e-mail, a blog, a tweeter, a face book, or the like, and to use a messenger service.

If a speech input icon 41 for inputting a speech is input, the transmission terminal 10 receives and transmits a transmitter's speech to the message server 20, and receives and displays a recognition result and N-best results transmitted from the message server 20.

If at least one of the N-best results is selected by the transmitter to decide a final message 43 and an evaluation result of accuracy of the corresponding message 43 are input in a process of displaying the recognition result and the N-best results, the transmission terminal 10 encrypts the evaluation result 42, the message 43, and/or position information of the speech stored in the message server 20, and transmits the encrypted data to the message server 20 and the reception terminal 30.

Here, the transmitter selects any one of the N-best results, which are the results of speech recognition arranged on the basis of the accuracy according to the speech recognition.

Accordingly, if a specified word is selected from the recognition result, the transmission terminal 10 arranges the N-best results of the selected word, and at this time, the transmitter selects any one of the N-best results.

The transmitter may select an accurate word that coincides with the input speech or a word that is different from the speech but most approaches the contents thereof in the whole context, and, based on this, decide the message 43 that is equal to or most approaches the contents of the speech input by the transmitter from the recognition result.

If the speech is input from the transmission terminal 10, the message server 20 performs the speech recognition through an unlimited continuous speech recognition device 22 as well as storing the speech, and transmits the recognition result and the N-best results to the transmission terminal 10. In addition, the message server 20 transmits the position information in which the speech is stored to the transmission terminal 10.

Thereafter, if the evaluation result 42 and the message 43 are input from the transmission terminal 10, the message server 20 stores them to improve the speech recognition performance. Further, if a speech request is received from the reception terminal 30, the message server 20 reads the speech from a data storage unit 23, and transmits the speech to the reception terminal 30.

The message server 20 as described above includes a data transmission/reception unit 21, the unlimited continuous speech recognition device 22, and a data storage unit 23.

The data transmission/reception unit 21 is connected to a wire/wireless communication network and provides a communication interface so that the transmission terminal 10 and the reception terminal 30 can transmit and receive various data.

The unlimited continuous speech recognition device 22 recognizes the speech that is transmitted from the transmission terminal 10 through the data transmission/reception unit 21.

If the speech is transmitted from the transmission terminal 10, the unlimited continuous speech recognition device 22 performs the speech recognition, outputs the results in a lattice form, changes the lattice form to a confusion network (CN) form, and generates N-best results based on the confusion network.

The data storage unit 23 stores various data transmitted/received between the transmission terminal 10 and the reception terminal 30.

In particular, the data storage unit 23 stores the speech transmitted from the transmission terminal 10, the recognition result recognized by the unlimited continuous speech recognition device 22, and the evaluation result 42 and the message 43 transmitted from the transmission terminal 10.

In this case, the data storage unit 23 stores the various data to be used as log data, and thus the speech recognition performance of the unlimited continuous speech recognition device 22 can be improved thereafter.

The reception terminal 30 may be one of various terminals, such as a smart phone, a personal computer, and the like, which makes it possible to register writing of an e-mail, a blog, a tweeter, a face book, or the like, and to use the messenger service.

If the message 43, the evaluation result 42, and the encrypted position information are transmitted from the transmission terminal 10, the reception terminal 30 displays the message 43 and the evaluation result 42 on a screen. At this time, it may be difficult for a receiver to accurately understand the contents of the message 43 due to the limit in speech recognition performance.

Accordingly, if the receiver requests the speech, the reception terminal 30 requests the speech from the message server 20 while transmitting position information of the corresponding speech to the message server 20, and at this time, the message server 20 reads the speech from the data storage unit 23 according to the position information and transmits the read speech to the reception terminal 30. Then, the reception terminal 30 outputs the corresponding speech, so that the receiver can recognize the contents of the message 43 through the speech.

For this, the reception terminal 30 may provide a speech output icon 44 for requesting and outputting the speech while outputting the message 43.

Further, if the evaluation result 42 is equal to or less than a preset level, the reception terminal 30 may automatically request the speech from the message server 20 to output the speech.

Hereinafter, the message service method using the speech recognition according to an embodiment of the present invention will be described in detail with reference to FIGS. 2 to 5.

First, if a command for transmitting or registering text or message 43 is input and then a speech input icon 41 is input to the transmission terminal 10, the transmission terminal 10 receives an input of the speech (S10).

If the speech is input, the transmission terminal 10 transmits the speech to the message server 20 (S12).

The message server 20 stores the speech transmitted from the transmission terminal 10 and performs the unlimited continuous speech recognition (S14).

In this case, the message server 20 recognizes the speech, generates the recognition result in a lattice form, changes the lattice form to a confusion network form, and generates N-best results based on the confusion network (S16).

Further, the message server 20 stores the recognition result and the N-best results for the speech as log data (S18).

As described above, once the recognition result and the N-best results are generated, the message server 20 transmits the recognition result, the N-best results, and the position information in which the speech is stored to the transmission terminal 10 (S20).

The transmission terminal 10 displays the recognition result and the N-best results transmitted from the message server 20 (S22).

At this time, the transmission terminal 10 determines whether the N-best results are applied to the recognition result from the transmitter.

Here, the N-best result may be selected by the whole sentence or a word constituting the sentence.

As described above, if the N-best result is selected and the final message 43 is decided, it is determined whether the evaluation result 42 obtained by evaluating the accuracy of the message 43 are input.

If the evaluation result 42 is input as the result of the decision, the message 43 and the evaluation result 42 are finally decided (S24).

This process will be described with reference to FIGS. 3 and 4.

For example, in the case where the transmission terminal 10 transmits the speech “What's for lunch today?” to the message server 20, it receives the recognition result from the message server 20 and displays the received recognition result. In addition, the transmitter can confirm the N-best results of “what's”, “for lunch”, and “today”.

That is, if the transmitter selects the recognition result that corresponds to “today” in the case where the recognition result of “today” that is the speech input by the transmitter is wrong, the transmission terminal 10 displays the N-best results, such as “for day”, “the day”, and “four day”, as shown in FIG. 4.

Accordingly, the transmitter selects any one, which most approaches “today” that the transmitter has spoken or is suitable to transfer the contents, among “for day”, “the day”, and “D-day”.

This process may be repeatedly performed with respect to the remaining speeches “what's” and “for lunch”. That is, the transmitter may select “where's” that is the N-best result corresponding to “what's”, and may select any one of “the lunch”, “for launch”, “four lunch”, and “for launching” that are the N-best results corresponding to “for lunch”.

For reference, if the recognition result of the word is accurate, the N-best result may not be selected.

In addition, the transmission terminal 10 may display the recognition result with different colors by words. In this case, it is possible to confirm whether there are N-best results for the respective words and to select the N-best results more easily.

Through the above-described process, the message server 20 finally selects the message 43 to be transmitted to the transmission terminal 30.

For reference, in this embodiment, it is exemplified that the message 43 is finally decided through selection of any one of N-best results arranged by words. However, the technical range of the present invention is not limited thereto, and the N-best results may be combined and arranged as a sentence and any one of them may be selected.

If the transmitter finally decides “What's the lunch for day?” as the message 43 as shown in FIG. 3 through the above-described process, the transmitter compares this with “What's for lunch today” that the transmitter has spoken, and inputs the evaluation result 42 obtained by evaluating the accuracy. FIG. 3 exemplarily shows that the evaluation result 42 is “3 points”.

In the case of expressing the evaluation result 42 with numerical values, examples of deciding the evaluation result 42 with respect to “What's for lunch today?” as described above are as follows.

5 points: in the case where the recognition result is satisfied (What's for lunch today?)

4 points: in the case where the recognition result is slightly wrong, but there is no problem in confirming the intended contents (What's the lunch today?)

3 points: in the case where unimportant words are wrong in transferring the message 43, but the contents of the message 43 can be predicted to some extent (What's the lunch for day?)

2 points: in the case where the important words are wrong and thus the contents cannot be known (where's for launch the day?)

1 point: in the case where the message 43 itself is completely wrong (Where's for launching D-day?)

On the other hand, the evaluation result 42 is not limited to the numerical values as shown in FIG. 3, but the selection method and the expression method may be further subdivided to display and select the evaluation result 42 in various ways using characters, patterns, symbols, and the like.

If the message 43 and the evaluation result 42 are decided as described above, the transmission terminal 10 transmits the message 43 and the evaluation result 42 to the message server 20 (S26), and transmits the message 43, the evaluation result 42, and the position information to the reception terminal 30 (S32). Here, the position information is encrypted to be transmitted.

If the message 43 and the evaluation result 42 are transmitted from the transmission terminal 10, the message server 20 additionally store them as log data (S28), and corrects errors of the recognition result using the log data (S30) to improve the speech recognition performance.

On the other hand, if the message 43, the evaluation result 42, and the position information are transmitted, the reception terminal 30 displays the message 43 and the evaluation result 42 as shown in FIG. 5 (S34).

At this time, if it is difficult for the receiver to understand the contents of the message 43 being displayed through the reception terminal 30, the receiver selects the speech output icon 44.

Through this, the reception terminal 30 requests the transmission of the corresponding speech from the message server 20 (S36), and the message server 20 extracts the speech using the position information of the corresponding speech (S38) and transmits the extracted speech to the reception terminal 30 (S40).

If the speech is transmitted from the message server 20, the reception terminal 30 outputs the speech through a speaker (not illustrated) so that the receiver can recognize the message 43 as the speech.

For reference, in this embodiment, in addition to the receiver's request for the speech as described above, the reception terminal 30 may automatically request the speech from the message server 20 and output the requested speech if the evaluation result 42 is equal to or less than the preset level.

In this case, the receiver can conveniently listen to the speech without any involved request for the speech.

Although it is exemplified that the reception terminal receives and outputs the whole speech of the transmitter in the above-described embodiment, the technical range of the present invention is not limited thereto, and it is also possible to request the speech by words from the message server to output the speech. In addition, if the evaluation result is equal to or less than the preset level, it is also possible to automatically request the speech by words from the message server to output the speech.

Through this, the data transmission rate can be further reduced, and the receiver can easily understand the contents of the message.

The embodiment of the present invention has been disclosed above for illustrative purposes. Those skilled in the art will appreciate that various modifications, additions and substitutions are possible, without departing from the scope and spirit of the invention as disclosed in the accompanying claims.

For example, in this embodiment, it is exemplified that a short message service is provided. However, the technical range of the present invention is not limited thereto, and the present invention can be adopted in registering writings in an e-mail, a blog, a tweeter, a face book, and the like, and in providing text transfer services including a messenger and the like.

What is claimed is:

1. A message service method using speech recognition comprising:
recognizing a speech transmitted from a transmission terminal;
generating and transmitting a recognition result of the speech and N-best results based on a confusion network to the transmission terminal; and
if a message selected by the transmission terminal and an evaluation result of accuracy of the message are transmitted, transmitting the message and the evaluation result to a reception terminal.

2. The message service method using speech recognition of claim 1, further comprising, if the message selected by the transmission terminal and the evaluation result of the accuracy of the message are transmitted, correcting an error of the recognition result by storing log data of the recognition result through storing of the message.

3. The message service method using speech recognition of claim 1, further comprising, if transmission of the speech is requested from the reception terminal, reading and transmitting the speech to the reception terminal.

4. A message service method using speech recognition comprising:
receiving and transmitting a speech to a message server;
receiving a recognition result of the speech and N-best results based on a confusion network from the message server;
displaying the recognition result and the N-best results and determining whether a message is selected and an evaluation result of the message are decided according to the recognition result and the N-best results; and
if the message and the evaluation result are decided, transmitting the message and the evaluation result to at least one of the message server and a reception terminal.

5. The message service method using speech recognition of claim 4, wherein in the step of determining whether the message is selected and the evaluation result of the message is decided, the recognition result is displayed with different colors by words, and if any one of the words is selected, any one of the N-best results of the selected word is selected and displayed.

6. The message service method using speech recognition of claim 1, wherein the message is selected and decided from the N-best results for the recognition result through the transmission terminal.

7. The message service method using speech recognition of claim 1, wherein the N-best results are generated by words or sentences.

8. The message service method using speech recognition of claim 1, wherein the evaluation result includes at least one of numeral values, characters, patterns, and symbols.

9. A message service method using speech recognition comprising:
receiving a message and an evaluation result from a transmission terminal or a message server; and
displaying the message and the evaluation result.

10. The message service method using speech recognition of claim 9, wherein the step of displaying the message and the evaluation result further includes, if the evaluation result is equal to or less than a set level, receiving the speech from the message server and automatically outputting the received speech.

11. The message service method using speech recognition of claim 4, wherein the message is selected and decided from the N-best results for the recognition result through the transmission terminal.

12. The message service method using speech recognition of claim 4, wherein the N-best results are generated by words or sentences.

13. The message service method using speech recognition of claim 4, wherein the evaluation result includes at least one of numeral values, characters, patterns, and symbols.
